(19) United States
(12) Patent Application Publication
(10) Pub. No.: US 2024/0009064 A1
(43) Pub. Date: Jan. 11, 2024

(54) WHEELED WALKING FRAME

(71) Applicant: Claudio Rosin, Cormons (IT)

(72) Inventor: Claudio Rosin, Cormons (IT)

(21) Appl. No.: 18/033,121

(22) PCT Filed: Oct. 26, 2021
(86) PCT No.: PCT/IT2021/050351

§ 371 Date: Apr. 21, 2023

(30) Foreign Application Priority Data
Oct. 29, 2020 (IT) 102020000025645

(51) Int. Cl. A61H 3/04

(52) U.S. Cl. CPC A61H 3/04; A61H 2003/046

(57) ABSTRACT

Walking frame (10) with wheels (12) comprising a support frame (11) provided with tubular elements (13) with which respective wheels (12) are associated.

### FIELD OF THE INVENTION

Embodiments described here concern a wheeled walking frame that can be used as an orthopedic device to facilitate and assist people with motor problems when walking.

### BACKGROUND OF THE INVENTION

Various types of walking frames are known, for different types of motor disabilities. Typically, these walking frames are provided with a support frame with a plurality of support points for contact with the ground and gripping elements which the user uses for support and/or to grip with his/her hands.

In particular, there are walking frames whose support points are fixed points, the disadvantage of which is that they need to be lifted every time the user has to advance a few steps. In addition to being tiring and uncomfortable in the long term, this can cause greater instability for the user as, every time the user lifts the walking frame, he/she loses its support and consequently risks falling.

Furthermore, this type of walking frame can only be used for short distances, since it requires constant physical effort and mental concentration on the part of the user.

There are also walking frames in which the support points are mobile points, called “rollators” in jargon, that is, provided with wheels in contact with the ground. Four wheels, or two fixed points and two wheels, can be provided. On the gripping elements there may be commands to operate the brakes on the wheels.

However, although it allows continuous walking, this type of wheeled walking frame requires a quick reflex on the part of the user who, in the event of possible instability, must exert an action on the brakes.

There are also wheeled walking frames equipped with a device to limit motion, configured to allow discreet control of the advance of the walking frame. One disadvantage of such walking frames is that the limiting device is very complex and requires modifications to be made to the structure of the walking frame on which it is to be mounted.

There is therefore a need to provide a wheeled walking frame that can overcome at least one of the disadvantages of the state of the art.

In particular, one purpose of the present invention is to provide a walking frame that provides the user with greater safety when walking than known walking frames.

Another purpose of the present invention is to provide a walking frame that provides an effective support action even in the event that the user loses his/her balance.

Another purpose of the present invention is to provide a walking frame that does not require significant physical efforts on the part of the user for moving the walking frame.

It is also a purpose of the present invention to provide a walking frame that can be used as an aid to walking even for long distances, without requiring excessive physical effort for the user.

Another purpose of the present invention is to provide a walking frame that is equipped with a limiting device for the discreet control of the user's advance, which is simple, very easy to install even on a traditional walking frame, and which consists of a number limited of components.

Another purpose of the present invention is to provide a walking frame having a selectively pre-adjustable forward travel. This is to increase the flexibility and range of use of the orthopedic device.

The Applicant has devised, tested and embodied the present invention to overcome the shortcomings of the state of the art and to obtain these and other purposes and advantages.

### SUMMARY OF THE INVENTION

The present invention is set forth and characterized in the independent claim.

The dependent claims describe other characteristics of the present invention or variants to the main inventive idea.

In accordance with the above purposes, a wheeled walking frame comprises a support frame with which respective wheels are associated and a unit to limit the forward travel configured to limit the rotation of at least one of the wheels.

According to one aspect, the limiting unit comprises an anti-rotation device provided at least with a fixed stop element and with a limiting mean which is selectively integral with at least one wheel in order to interfere with a first side of the stop element and block the advance of the walking frame, or which is able to be selectively distanced from at least one wheel in order to interfere with a second side of the stop element and restore a new travel of the walking frame.

According to another aspect, the limiting mean comprises a first disc coaxial to the at least one wheel and on which a slot is perimetrally made along a segment of arc having a length correlated to a predefined angle of rotation. The slot has, at the respective ends, a first and a second end-of-travel abutment, wherein the first disc is alternatively disposed between a condition of contact with at least one wheel and a distanced condition from at least one wheel.

According to another aspect, the fixed stop element projects from the support frame and is inserted in the slot.

According to another aspect, in the condition of contact the first disc is configured to pass from a position of advance, in which it is in an angular position such that the second end-of-travel abutment abuts on the stop element, to a blocking position, in which it is in an angular position such that the first end-of-travel abutment abuts on the stop element. In the distanced condition, the first disc is uncoupled from the wheel and is configured to rotate in the opposite sense to that which causes the advance of the walking frame.

According to another aspect, the anti-rotation device comprises return means configured to activate the rotation of the first disc from the blocking position to the position of advance when it is in the distanced condition as above.

According to another aspect, the limiting mean is provided with interference elements present on a surface thereof facing toward at least one wheel which are configured to couple indirectly or directly therewith, in order to make the limiting mean integral with the at least one wheel.

According to another aspect, the walking frame comprises an actuation device configured to deactivate the anti-rotation device so as to restore a new travel of the walking frame and a transmission unit. The transmission unit comprises a rigid guide member, sliding on a tubular element of the support frame and a first cable, made through in the guide member, connected on one side to the actuation device and on the opposite side to the anti-rotation device in order to move the limiting mean from the position integral with the wheel to the position distanced from the wheel.

According to another aspect, the limiting unit comprises an angular adjustment mechanism associated with the anti-rotation device and configured to selectively determine the pre-adjustment of the angle of rotation as above which is correlated to a pre-selected limited forward travel of the walking frame. This solution advantageously allows to make the walking frame particularly flexible since the forward travel can, on each occasion, be selected and adjusted according to the user's needs.

### BRIEF DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a perspective view of a walking frame in accordance with embodiments described here;

FIG. 2 is an enlarged detail of FIG. 1;

FIG. 3 is a lateral view of the limiting unit-wheel assembly in which the first disc is in a condition of contact and in a position of advance;

FIG. 4 is a lateral view of the limiting unit-wheel assembly in which the first disc is in a condition of contact and in a blocking position;

FIG. 5 is a lateral view of the limiting unit-wheel assembly in which the first disc is in a distanced condition and still in the blocking position;

FIG. 6 is a lateral view of the limiting unit-wheel assembly in which the first disc is in a distanced condition, but returned to the position of advance;

FIG. 7 is a section along line VII-VII of FIG. 3;

FIG. 8 is a section along line VIII-VIII of FIG. 4;

FIG. 9 is a section along line IX-IX of FIG. 5;

FIG. 10 is a section along line X-X of FIG. 6;

FIG. 11 is a variant of FIG. 2;

FIG. 12 is a lateral view of the limiting unit-wheel assembly in which the angular adjustment mechanism is present;

FIG. 13 is a section along line XIII-XIII of FIG. 12.

To facilitate comprehension, the same reference numbers have been used, where possible, to identify identical common elements in the drawings. It is understood that elements and characteristics of one embodiment can conveniently be combined or incorporated into other embodiments without further clarifications.

### DETAILED DESCRIPTION OF SOME EMBODIMENTS

We will now refer in detail to the possible embodiments of the invention, of which one or more examples are shown in the attached drawings, by way of a non-limiting illustration. The phraseology and terminology used here is also for the purposes of providing non-limiting examples.

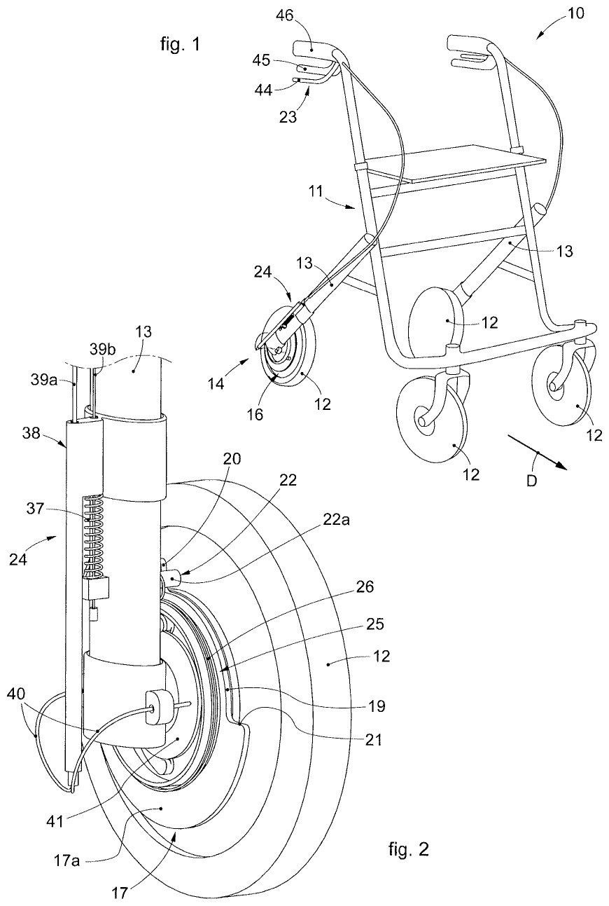

The embodiments described here concern a walking frame 10 with wheels 12, FIG. 1.

The walking frame 10 comprises a support frame 11 provided with tubular elements 13 with which respective wheels 12 are associated.

The walking frame 10 comprises a unit 14 to limit the forward travel, configured to limit the rotation of at least one of the wheels 12 only for a predefined angle of rotation a correlated to a predefined limited forward travel of the walking frame 10.

The limiting unit 14 comprises an anti-rotation device 16 to block the rotation of at least one of the wheels 12 of the walking frame 10 in a forward direction of normal advance D of the walking frame 10.

According to one aspect, the anti-rotation device 16 is provided at least with a fixed stop element 22 and with a limiting mean 17 which is selectively integral with at least one of the wheels 12 in order to interfere with a first side of the stop element 22 and block the advance of the walking frame 10, or able to be selectively distanced from the wheel 12 in order to interfere with a second side of the stop element 22 and restore a new travel of the walking frame 10.

The limiting mean 17 comprises a first disk 17a pivoted to the same rotation shaft 18 of the at least one wheel 12.

The first disc 17a is selectively mobile between a condition of direct or indirect contact with the wheel 12 and a distanced condition from the wheel 12.

The first disc 17a is normally disposed in a condition of contact with the wheel 12. In the condition of contact, the first disc 17a can rotate integrally with the wheel 12 following a rotation thereof.

When the first disc 17a is in the distanced condition, the first disc 17a is free to rotate independently with respect to the wheel 12, while the wheel 12 remains advantageously blocked by the action of a brake 15, as will be described in more detail below. In particular, in the distanced condition the first disc 17a is released from the wheel 12.

The anti-rotation device 16 comprises a slot 19 perimetrally made on the first disc 17a along a segment of arc having a length correlated to the predefined angle of rotation a. The slot 19 has, at the respective ends, a first 20 and a second 21 end-of-travel abutment.

The stop element 22 is configured as a fixed limiting pin 22a that projects from the tubular element 13 and is inserted in the slot 19.

In the condition of contact, the first disc 17a can be in a position of advance or in a blocking position.

In the position of advance, the first disc 17a is in an angular position such that the second end-of-travel abutment 21 abuts on the limiting pin 22a.

In the blocking position, the first disc 17a is in an angular position such that the first end-of-travel abutment 20 abuts on the limiting pin 22a.

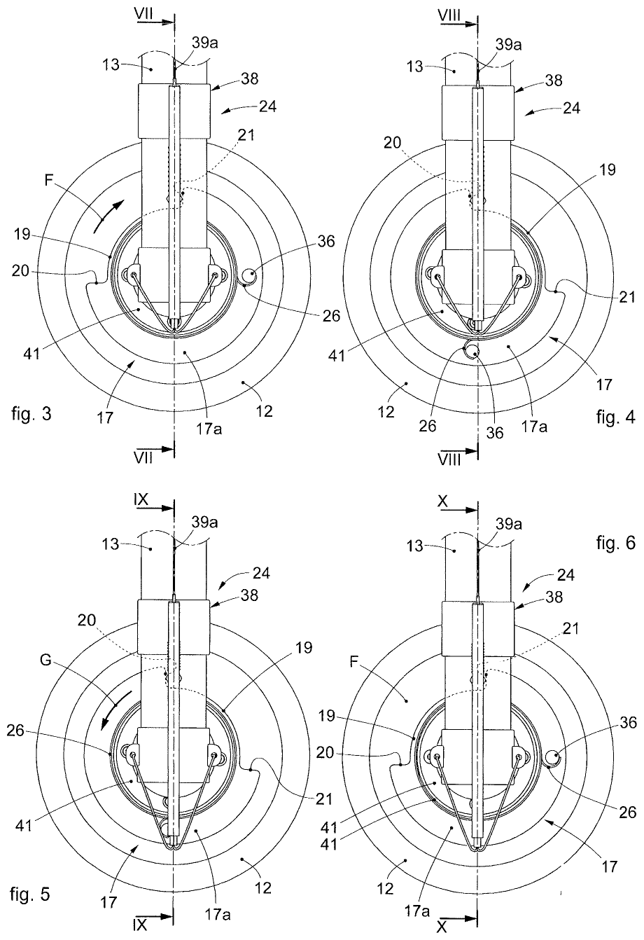

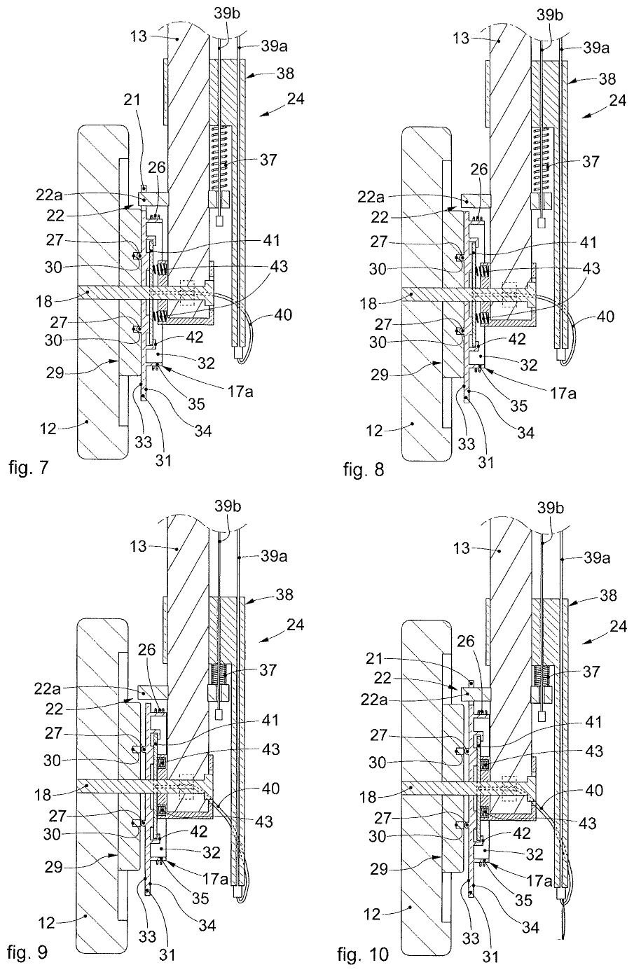

When the first disc 17a is in the condition of contact and in the position of advance, FIG. 3 and FIG. 7, it is able to rotate integrally with the wheel 12, in the sense indicated by the arrow F of FIG. 3, until it reaches the blocking position, FIG. 4 and FIG. 8, for the purpose of the advance of the walking frame 10 by a predefined and limited travel in the direction of normal advance D.

Once the blocking position has been reached, the advance of the walking frame 10 is temporarily denied, FIG. 4 and FIG. 8.

The first disc 17a is then configured to be taken in the distanced condition in which it is uncoupled from the wheel 12, FIG. 5 and FIG. 9, and is able to rotate freely in the sense, indicated by the arrow G of FIG. 5, opposite to the one that causes the advance of the walking frame 10 in order to move once again from the blocking position to the position of advance, FIG. 6 and FIG. 10.

The anti-rotation device 16 comprises return means 25 configured to activate the rotation of the first disc 17a, when it is in the distanced condition, from the blocking position to the position of advance, in order to restore a new predefined and limited travel of the walking frame 10 in the direction of normal advance D.

The return means 25 can be of the mechanical or electromechanical type.

In the example described here, the return means 25 are of the mechanical type and comprise a torsion-type spring 26 configured to load when the first disc 17a is in the condition of contact and passes from the position of advance to the blocking position, and to unload when the first disc 17a is in the distanced condition allowing the rotation of the first disc 17a from the blocking condition to the condition of advance.

In possible embodiments, the spring 26 can be suitably pre-loaded.

With particular reference to FIG. 1, the walking frame 10 comprises an actuation device 23 configured to command, by means of a command lever 44, the deactivation of the anti-rotation device 16 in such a way as to take the first disc 17a from the condition of contact to the distanced condition, and a transmission unit 24 connected on one side to the actuation device 23 and on the opposite side to the anti-rotation device 16.

According to some embodiments, the first disc 17a is provided with interference elements 27 present on the surface that faces toward the wheel 12 and configured to indirectly or directly couple to the latter in order to make the first disc 17a integral with the wheel 12, when the first disc 17a is in the condition of contact.

The interference elements 27 can be configured as protrusions that project from the surface of the first disc 17a which faces toward the wheel 12.

The interference elements 27 can be made in a single body with the first disc 17a or they can be distinct and separate components from the first disc 17a. In the latter case, the interference elements 27 can comprise, for example, pins, rivets, screws, or other similar or comparable elements disposed in such a way as to protrude from the surface referenced above.

In the example described here and with reference to the condition of contact, the first disc 17a is indirectly coupled to the wheel 12. In fact, between the first disc 17a and the wheel 12 there is a second disc 29 that has, on the surface facing toward the first disc 17a, corresponding cavities 30 able to accommodate the interference elements 27. The second disc 29 is centrally attached to the wheel 12 and is coaxial with the rotation shaft 18.

According to one variant, the cavities 30 can be made directly on the wheel 12.

According to another variant, the wheel 12 or the second disc 29 are provided with the interference elements 27, while the first disc 17a is provided with the cavities 30.

In the example described here, there are four interference elements 27 and four corresponding cavities 30 disposed along respective circumferences of the first disc 17a and the second disc 29 respectively, and they are angled with respect to each other by about 90°.

According to some embodiments, the first disc 17a has a plate 31 and a drum 32 that projects from the plate 31, from the surface opposite to that facing toward the wheel 12.

The plate 31 has a central hole in which the rotation shaft 18 is made through.

The plate 31 and the drum 32 can be made in a single piece.

The plate 31 has a contact surface 33 on which the interference elements 27 are present, and an opposite abutment surface 34 from which the drum 32 projects.

The drum 32 is coaxial with the central hole and comprises an annular wall 35 on the external surface of which the torsion-type spring 26 is wound.

The annular wall 35 develops around the central hole and has a radial and axial size sufficient to allow the installation and functioning of the spring 26.

The spring 26 has a first end attached to the first disc 17a and a second end attached to the support frame 11.

In the example described here, the disc 17a has a fastening pin 36 to which the first end of the spring 26 is attached. The second end of the spring 26 is fastened to the limiting pin 22.

According to some embodiments, the plate 31 has a circular shape and is peripherally provided with the slot 19.

The slot 19 is disposed at a radial height greater than that which defines the radial position of the annular wall 35 of the drum 32.

The slot 19 is open in the radial direction and in the direction of the axis of rotation of the wheel 12.

In possible embodiments, the slot 19 is configured as a pocket open only in the direction of the limiting pin 22a.

According to possible embodiments, the first disc 17a can be solid and the slot 19 can be defined by a pair of abutment elements angularly distanced on the periphery of the first disc 17a by an angular height equal to the angle of rotation a and configured for interfere with the limiting pin 22a as described above.

According to some embodiments, the transmission unit 24 comprises a rigid guide member 38, sliding on the tubular element 13, a first cable 39a made through in the guide member 38 and connected on one side to the anti-rotation device 16 and on the opposite side to the actuation device 23, and a second cable 39b connected on one side to the brake 15 and on the opposite side to the actuation device 23.

Advantageously, the first cable 39a and the second cable 39b are two distinct and separate components.

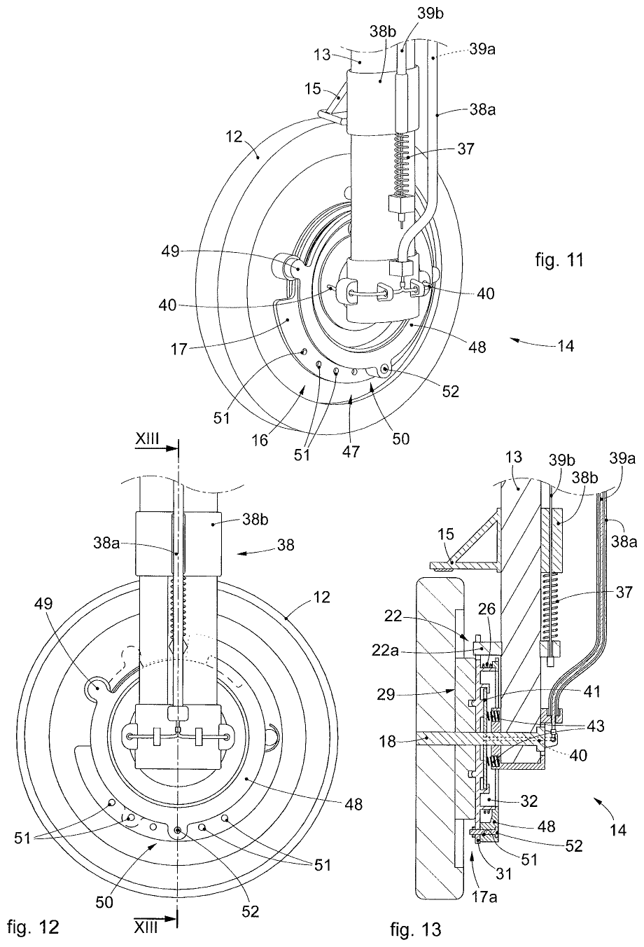

The guide member 38 can be a single body, as shown in FIGS. 1-10, or it can comprise, as can be seen in FIGS. 11-13, a first guide portion 38a, inside which the first cable 39a is sliding, and a second guide portion 38b, inside which the second cable 39b is sliding, wherein the second guide portion 38b is distinct and separate from the first guide portion 38a.

In particular, the first cable 39a has at least one terminal cable portion 40 guided in a direction parallel to the axis of rotation of the wheel 12 and directly or indirectly associated with the first disk 17a. A pull of the terminal cable portion 40 allows to move the first disc 17a from the condition of contact to the distanced condition.

According to some embodiments, the transmission unit 24 comprises a plate 41 interposed between the first disk 17a and the tubular element 13.

The plate 41 is coupled with clearance to the first disc 17a cooperating on each occasion with the abutment surface 34 of the latter. The coupling is guaranteed by means of stop elements 42 which can be made in a single body with the first disc 17a or which can be distinct and separate components such as, for example, screws or other similar or comparable means.

With reference to FIG. 2 and FIG. 11, the first cable 39a is attached to the plate 41. When the first cable 39a is driven, the plate 41 pulls the first disc 17a with it, releasing it from the second disc 29.

The transmission unit 24 comprises elastic means 43 interposed between the plate 41 and the tubular element 13 and configured to thrust the plate 41 against the first disk 17a in order to return it from the distanced condition to the condition of contact. This thrusting action occurs simultaneously with the counter-rotation of the first disc 17a, from the blocking position to the position of advance, generated by the spring 26.

In particular, when the user interrupts the action exerted on the actuation device 23 by means of the command lever 44, the elastic means 43 allow the repositioning of the first disc 17a in the condition of contact and recall means 37 associated with the guide member 38 assist its ascent in order to correctly reposition at least the second cable 39b, and at the same time move the brake 15 away from the rolling surface of the wheel 12.

The brake 15, visible in the example embodiments of FIG. 11 and FIG. 13, is operatively associated with at least one of the wheels 12 in order to block its rotation, when necessary. The brake can be driven by means of a brake lever 45, FIG. 1.

The brake lever 45 can be an independent and autonomous component with respect to the command lever 44, or it can be integrated or coincident with the command lever 44 in such a way that when the anti-rotation device 16 is deactivated, the brake is simultaneously driven and the walking frame 10 is completely blocked in complete safety. This second configuration can be preferable because it allows greater safety when using the walking frame 10.

The brake lever 45 and the command lever 44 can be associated with a gripping element 46 that can be gripped by a user, FIG. 1.

According to some embodiments, shown in FIGS. 11-13, the limiting unit 14 comprises an angular adjustment mechanism 47 associated with the anti-rotation device 16 and configured to selectively determine the angle of rotation a allowed for the rotation of the wheel 12.

The adjustment of the angle of rotation a is performed before using the walking frame 10 and can be provided whenever this parameter is to be changed, for example to meet the different walking needs of the user. This adjustment allows to increase the flexibility of use of the walking frame 10.

The angular adjustment mechanism 47 comprises an adjustment disk 48 coaxial and coupled to the first disk 17a in an angular position selectively adjustable with respect to the latter.

The adjustment disk 48 is associated with the drum 32 of the first disk 17a, thus helping to radially contain the spring 26, FIG. 13. The adjustment disk 48 is substantially parallel with respect to the plate 31 of the first disk 17a.

The adjustment disk 48 is integral with the first disk 17a and has a radial size smaller than the radial size of the latter, and also smaller than the height at which the stop element 22 is located.

The adjustment disk 48 is positioned between the first disk 17a and the tubular element 13 to which the wheel 12 on which the limiting unit 14 acts is attached.

The angular adjustment mechanism 47 comprises a contrast element 49 protruding radially and axially from the adjustment disk 48 and disposed inside the slot 19, between the first end-of-travel abutment 20 and the second end-of-travel abutment 21, in order to limit, according to the adjustment provided, the circumferential extension of the slot 19.

The angular rotation is therefore defined by the angular distance between the contrast element 49 and the first 20 or second 21 end-of-travel abutment, depending on the position of the contrast element with respect to the stop element 22.

The contrast element 49 can therefore be provided between the first end-of-travel abutment 20 and the stop element 22, or between the stop element 22 and the second end-of-travel abutment 21.

The contrast element 49 has an axial size, measured in a direction parallel to the axis of rotation of the wheel 12, sufficiently wide to interfere with the stop element 22.

With particular reference to FIGS. 11-12, the contrast element 49 is disposed between the first end-of-travel abutment 20 and the stop element 22. In this configuration, the contrast element 49 replaces the first end-of-travel abutment 20, reducing the angular arc of the slot 19 and consequently limiting the forward travel of the walking frame 10.

In the embodiment described in FIGS. 11-13, the contrast element 49 is made in a single body with the adjustment disk 48. However, it is not excluded that the contrast element 49 may be an independent element associated with the adjustment disk 48 in a known way.

The angular adjustment mechanism 47 also comprises adjustment means 50 configured to stably fix the angular position of the adjustment disk 48 with respect to the first disk 17a.

The adjustment means 50 comprise a plurality of adjustment holes 51 made on the perimeter strip of the plate 31 of the first disc 17a, complementary to the slot 19, and at least one blocking element 52 able to block the adjustment disc 48 to the first disc 17a through the adjustment holes 51.

The blocking element 52 can be selected from a group comprising an adjustable screw, a rivet, a pin or other similar or comparable devices.

The adjustment holes 51 are made through in the plate 31 and can be angularly equidistant. For example, the adjustment holes 51 can be disposed at a reciprocal angular distance comprised between about 100 and about 20°, preferably around 15°.

The adjustment holes 51 can be made on the entire perimeter strip of the plate 31 which does not affect the slot 19, or only on a limited portion thereof.

The adjustment disk 48 can therefore be positioned according to a plurality of stable positions defined by the angular position of the adjustment holes 51.

According to possible embodiments, the walking frame 10 can comprise disengagement means able to temporarily release the limiting mean 17 in order to allow the continuous advance of the walking frame 10, as occurs for traditional walking frames. These disengagement means are configured to keep the first disc 17a in a distanced condition without there being an action by the user on the actuation device 23.

The disengagement means can comprise an adjustment screw, a pin or other suitable device and they can be directly associated with the limiting unit 14 or they can be disposed in a remote position close to the actuation device 23.

The disengagement means can comprise, as an alternative or in addition, an electromechanical disengagement device to facilitate this operation.

It is clear that modifications and/or additions of parts may be made to the walking frame 10 as described heretofore, without departing from the field and scope of the present invention as defined by the claims.

In the following claims, the sole purpose of the references in brackets is to facilitate reading: they must not be considered as restrictive factors with regard to the field of protection claimed in the specific claims.

1. Walking frame comprising a support frame with which respective wheels are associated, and a unit to limit the forward travel configured to limit the rotation of at least one of said wheels, characterized in that said limiting unit comprises an anti-rotation device provided at least with a fixed stop element and with a limiting mean selectively integral with at least one said wheel in order to interfere with a first side of said stop element and block the advance of said walking frame, or able to be selectively distanced from at least one said wheel in order to interfere with a second side of said stop element and restore a new travel of said walking frame.

2. Walking frame as in claim 1, characterized in that said limiting mean comprises a first disk coaxial to said at least one wheel and on which a slot is perimetrally made along a segment of arc having a length correlated to a predefined angle of rotation and having, at the respective ends, a first and a second end-of-travel abutment, wherein said first disk is alternatively disposed between a condition of contact with at least one said wheel and a distanced condition from at least one said wheel.

3. Walking frame as in claim 1, characterized in that said stop element is configured as a fixed limiting pin which projects from said support frame and is inserted in said slot.

4. Walking frame as in claim 2, characterized in that said first disc in the condition of contact is configured to pass from a position of advance, in which it is in an angular position such that said second end-of-travel abutment abuts on said stop element, to a blocking position, in which it is in an angular position such that said first end-of-travel abutment abuts on said stop element, and in that in the distanced condition said first disk is uncoupled from said wheel and is configured to rotate in the opposite sense to that which causes the advance of said walking frame.

5. Walking frame as in claim 4, characterized in that said anti-rotation device comprises return means configured to activate the rotation of said first disk from said blocking position to said position of advance when it is in said distanced condition, and in that said return means comprise a spring, associated with a first end with said first disk and with a second end with said support frame.

6. Walking frame as in claim 1, characterized in that said limiting mean is provided with interference elements present on a surface thereof facing toward at least one wheel which are configured to couple indirectly or directly therewith, in order to make said limiting mean integral with said at least one wheel.

7. Walking frame as in claim 2, characterized in that said first disk cooperates with a second disk integral with at least one said wheel and having cavities able to accommodate interference elements of said first disk.

8. Walking frame as in claim 1, characterized in that it comprises an actuation device configured to deactivate said anti-rotation device so as to restore a new travel of said walking frame and a transmission unit comprising a rigid guide member, sliding on a tubular element of said support frame, and a first cable, made through in said guide member, connected on one side to said anti-rotation device and on the opposite side to said actuation device.

9. Walking frame as in claim 8, characterized in that said first cable has at least one terminal cable portion guided in a direction parallel to the axis of rotation of said at least one wheel and directly or indirectly associated with said limiting mean in order to allow its decoupling from said at least one wheel.

10. Walking frame as in claim 8, characterized in that said transmission unit comprises a plate, interposed between said first disk and said tubular element, coupled with clearance to said first disc, and elastic means interposed between said plate and said tubular element in order to thrust said plate against said first disc in order to return it from said distanced condition to said condition of contact.

11. Walking frame as in claim 1, characterized in that said limiting unit comprises an angular adjustment mechanism associated with said anti-rotation device and configured to selectively determine the pre-adjustment of an angle of rotation correlated to a pre-selected limited forward travel of said walking frame.
